(19) United States
(12) Patent Application Publication
(10) Pub. No.: US 2017/0135880 A1
(43) Pub. Date: May 18, 2017

(54) Novel Hospital Bed Fall Prevention Methods and Systems

(71) Applicants: Vlastimil Smetka, Columbia, SC (US); Derrin Compton, US, SC (US)

(72) Inventors: Vlastimil Smetka, Columbia, SC (US); Derrin Compton, US, SC (US)

(21) Appl. No.: 14/945,119

(22) Filed: Nov. 18, 2015

(51) Int. Cl. A61G 7/008; A61G 7/015; A61G 7/005; A61G 7/05

(52) U.S. Cl. CPC A61G 7/008; A61G 7/0507; A61G 7/015; A61G 7/005

(57) ABSTRACT

Methods and systems for monitoring of the position of a patient in a hospital bed and taking responsive protective measures to continually reposition the patient in the center of the bed and to prevent the patient from accidentally falling or voluntarily exiting from the bed.

### CROSS-REFERENCE TO RELATED APPLICATIONS

U.S. Provisional Application No. 62081600

### STATEMENT REGARDING FEDERALLY SPONSORED RESEARCH OR DEVELOPMENT

Not Applicable

### NAMES OF PARTIES TO JOINT RESEARCH AGREEMENT

Not Applicable

### REFERENCE TO SEQUENCE LISTING, A TABLE, OR A COMPUTER PROGRAM LISTING COMPACT DISC APPENDIX

Not Applicable

### STATEMENT REGARDING PRIOR DISCLOSURES BY AN INVENTOR OR JOINT INVENTOR

Not Applicable

### BACKGROUND OF THE INVENTION

The inventive subject matter relates to hospital beds.

It is a well-known problem that many patients accidentally fall from hospital beds or intentionally exit hospital beds in unstable conditions and become injured. The National Patient Safety Foundation recently reported that approximately 500,000 falls occur in hospitals in the United States annually, and more than 150,000 injuries are attributed to such falls.

There have been various attempts to address this problem over time, namely, strapping the patient to the bed, attaching guards along the perimeter of the bed, and installing alarm systems. Each of these solutions has limitations and drawbacks.

Strapping the patient to the bed is effective for confinement purposes, but requires time consuming and intensive physical labor from health providers and can be detrimental to the patient's health and comfort because it restrains the patient's movements. For example: U.S. Pat. No. 2,706,477, Daake, 1955 (“Restraining sheet”).

Attaching guards along the perimeter of the bed is moderately effective for confinement purposes, but many patients roll or climb over the guards, and the guards often interfere with access to the patient. For example: U.S. Pat. No. 2,669,732, Moon, 1954 (“Guard for beds”).

Alarm systems provide a passive solution, requiring health care providers to respond and take physical action to prevent the patient from falling or exiting from the bed. For example: U.S. Pat. No, 2,784,395, Gorby, 1957 (“Patient fall-out warning device for hospital beds”); U.S. Pat. No. 5,276,432, Travis, 1994 (“Patient exit detection mechanism for hospital bed”); U.S. Pat. No. 7,437,787, Bhai, 2008 (“Load-cell based hospital bed control”); U.S. Pat. No. 8,717,181, Talent, 2014 (“Bed exit alert silence with automatic re-enable”).

There is a need for a better solution to this problem.

All patents and patent applications referenced herein are incorporated in their entirety. Where a definition or use of a term in a reference is inconsistent or contrary to the definition or use of that term herein, the definition or use of the term herein shall apply.

### BRIEF SUMMARY OF THE INVENTION

The present invention is directed to methods and systems for preventing a patient from accidentally falling or intentionally exiting from a hospital bed. The inventive subject matter involves monitoring the position of a patient on the bed and responsively repositioning and protecting the patient by tilting or shaping the bed to create an inclined plane gravitational force on the patient toward the center of the bed, or raising one or more guards around the perimeter of the bed. The inventive subject matter further involves steps and mechanisms to perform these functions and optional steps and mechanisms to optimize and customize performance based on the needs of the patient.

The advantages of the invention include favorable contrasts to the limitations and drawbacks of the existing solutions to the problem discussed above. The invention protects the patient with minimal detrimental impact on the patient's health or comfort, interference with access to the patient, and physical actions required from health care providers.

Various objects, features, aspects, and advantages of the present invention will become more apparent from the following detailed description of preferred embodiments of the invention, along with the accompanying drawing in which like numerals represent like components.

### BRIEF DESCRIPTION OF THE SEVERAL VIEWS OF THE DRAWING

FIG. 1 shows a perspective view of a patient centered in a hospital bed and monitoring aspects of an embodiment of the invention.

FIGS. 2(a) and 2(b) show perspective views of movement by a patient in a hospital bed and responsive repositioning and protective aspects of an embodiment of the invention.

FIGS. 3(a) and 3(b) show perspective views of movement by a patient in a hospital bed and responsive repositioning and protective aspects of an embodiment of the invention.

FIGS. 4(a) and 4(b) show perspective views of movement by a patient in a hospital bed and responsive repositioning and protective aspects of an embodiment of the invention.

FIG. 5 shows a perspective view of responsive repositioning and protective aspects of an embodiment of the invention.

FIGS. 6(a) and 6(b) show perspective views of movement by a patient in a hospital bed and responsive protective aspects of an embodiment of the invention.

FIG. 7 shows a perspective view of mechanisms controlled by the computer system that can enable repositioning and protective aspects of an embodiment of the invention.

FIG. 8(a) shows a perspective view of mechanisms controlled by the computer system that can enable repositioning and protective aspects of an embodiment of the invention and

FIG. 8(b) shows an enlarged view of a portion of FIG. 8(a).

FIG. 9 is a flow chart of an algorithm for a computer program that controls monitoring, repositioning, and protective aspects of various embodiments of the invention.

### DETAILED DESCRIPTION OF THE INVENTION

There are many possible embodiments of the invention, some of which are described below.

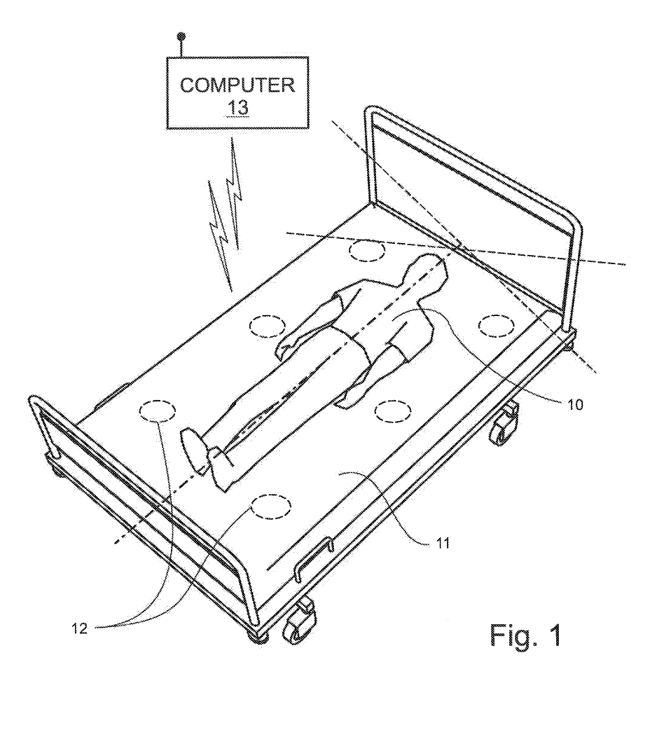

In further detail, FIG. 1 shows a patient 10 positioned in the center of a hospital bed patient support structure 11 with sensors 12 that communicate with a computer system 13 to monitor the size and position of the patient 10 on the patient support structure 11. Enabling examples of these features are described in U.S. Pat. No. 8,717,181. The sensors 12 may comprise any type of device that can communicate data about physical bodies, including, for example, weight load sensors, cameras, heat sensors, touch sensors, proximity sensors, or air pressure sensors, force sensitive resistors, capacitive sensors, tape switches, and including but not limited to the devices described in U.S. Pat. No. 8,717,181.

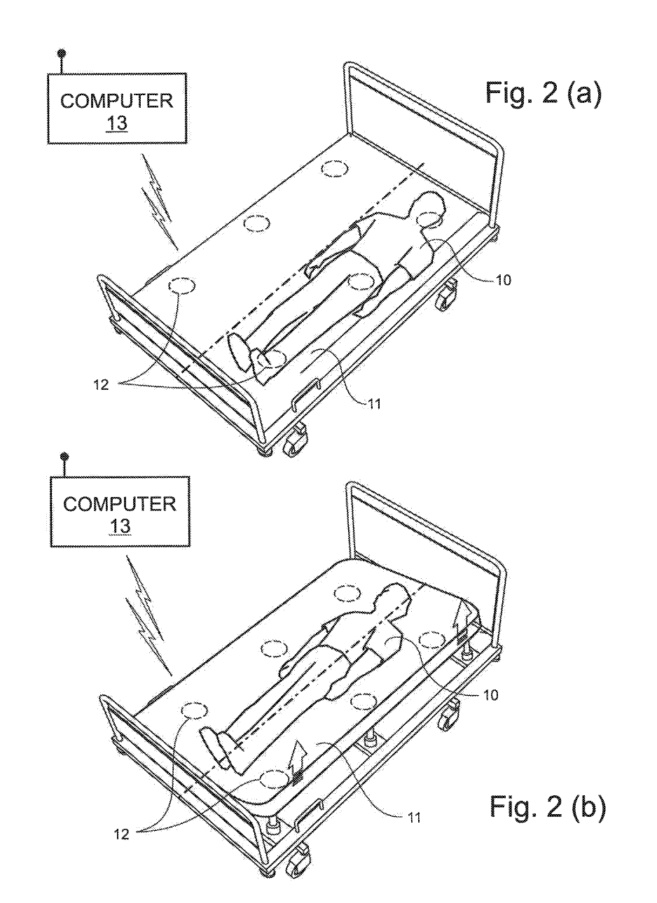

In further detail, FIGS. 2, 3, 4, and 5 show movement by the patient 10 away from the center of the patient support structure 11 monitored by the sensors 12 and communicated to the computer system 13 and various means for responsively manipulating the patient support structure 11 to create an inclined plane gravitational force on the patient in the direction of the center of the patient support structure 11 relative to the position of the patient 10. The initiation and magnitude of this force is controlled by the computer system 13. The computer system can be programed to initiate this force when the position of the patient 10 in the patient support structure 11 is determined to be outside of any chosen deviation (including zero) from the center (or a defined central area) of the patient support structure, such that the patient support structure otherwise remains level. The computer system 13 can be programmed to control the magnitude of this force by choosing any constant angle or calculating the angle of the inclined plane created as a factor of one or more of the following: the deviation of the position of the patient from the center (or a defined central area) of the patient support structure 11; and the size of the patient 10.

The inclined plane gravitational force on the patient has two effects. First, the force can reposition the patient in the center of the bed, either actively, by causing the patient to roll or slide, or passively, by causing the patient to choose to move to the center of the bed to make the bed level. Second, even if the force does not reposition the patient in the center of the bed, the force makes it more difficult for the patient to accidental fall or voluntarily exit from the bed. Among the advantages of this aspect of invention are that the force exerted on the patient has no or minimal detrimental impact on the patient's health or comfort; the force does not interfere with access to the patient; and the force does not require any physical action from health care providers.

In further detail, FIG. 2(a) shows movement of the patient 10 to the right side of the patient support structure 11 and FIG. 2(b) shows the patient support structure 11 responsively manipulated to create an inclined plane gravitational force by tilting the patient support structure 11 on its longitudinal axis.

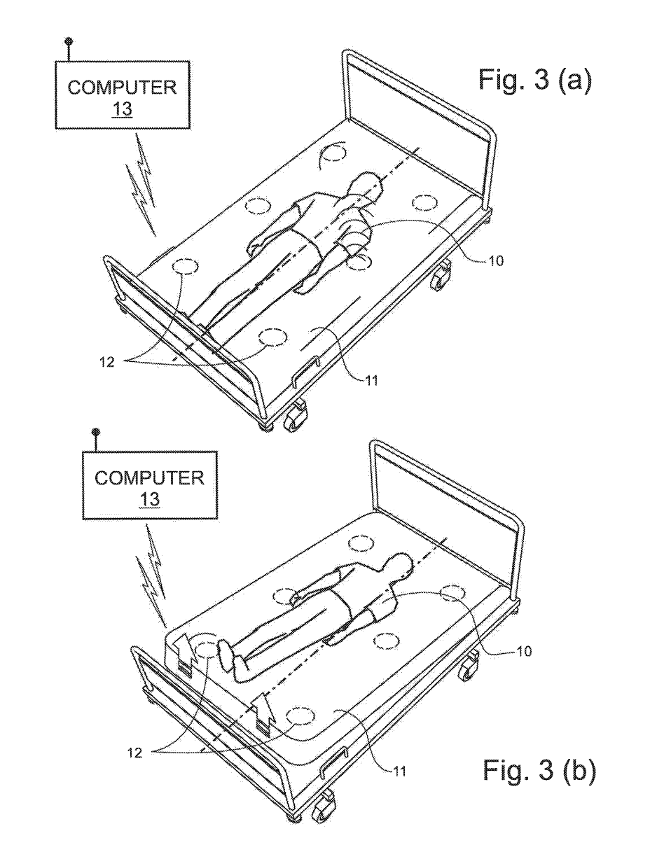

In further detail, FIG. 3(a) shows movement to the bottom of the patient support structure 11 and FIG. 3(b) shows the patient support structure 11 responsively manipulated to create an inclined plane gravitational force by tilting the patient support structure 11 on its transverse axis.

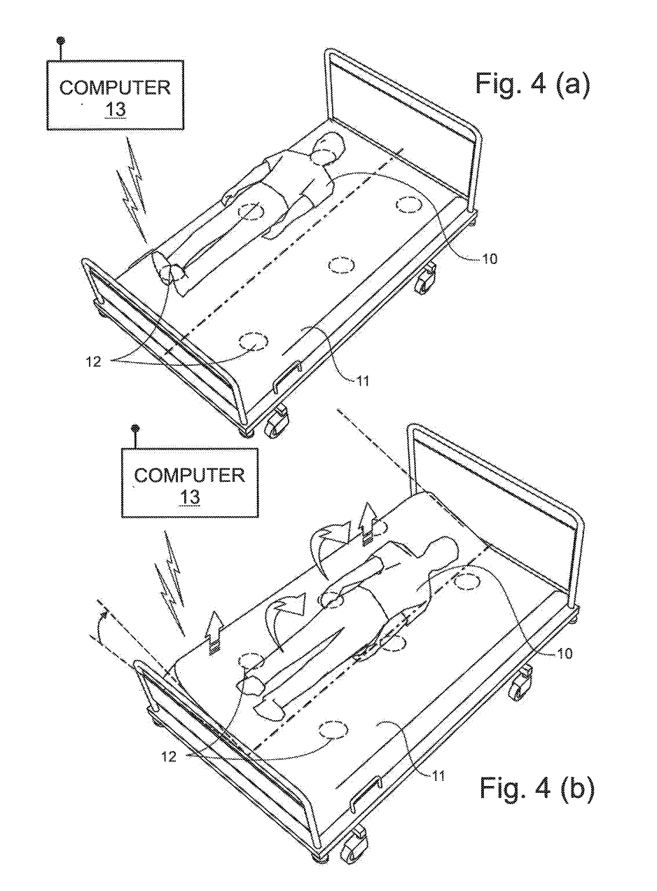

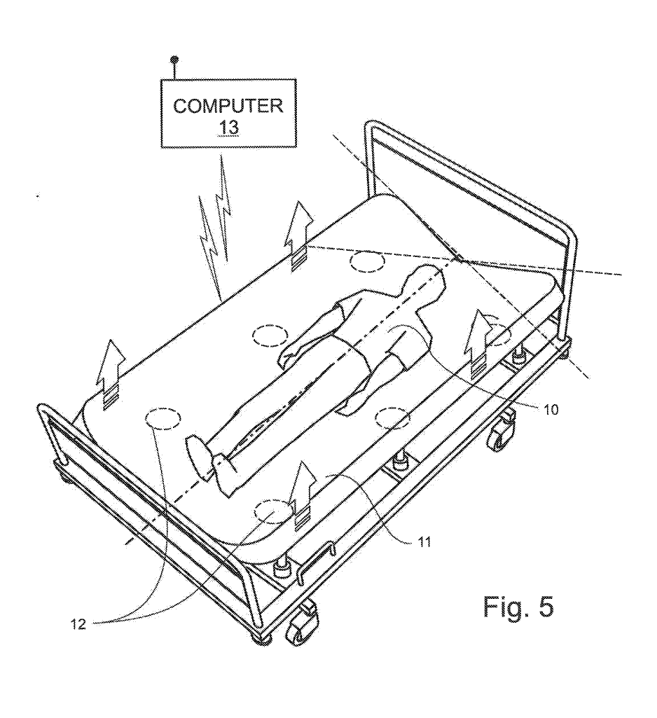

In further detail, FIG. 4(a) shows movement of the patient 10 to the left side of the patient support structure 11 and FIG. 4(b) shows the patient support structure 11 responsively manipulated to create an inclined plane gravitational force by adjusting the patient support structure 11 into a shape where its left side is higher than its center. It is also contemplated that any one or more of the sides or top or bottom of the patient support structure 11 can be responsively manipulated above its center, as exemplified in FIG. 5.

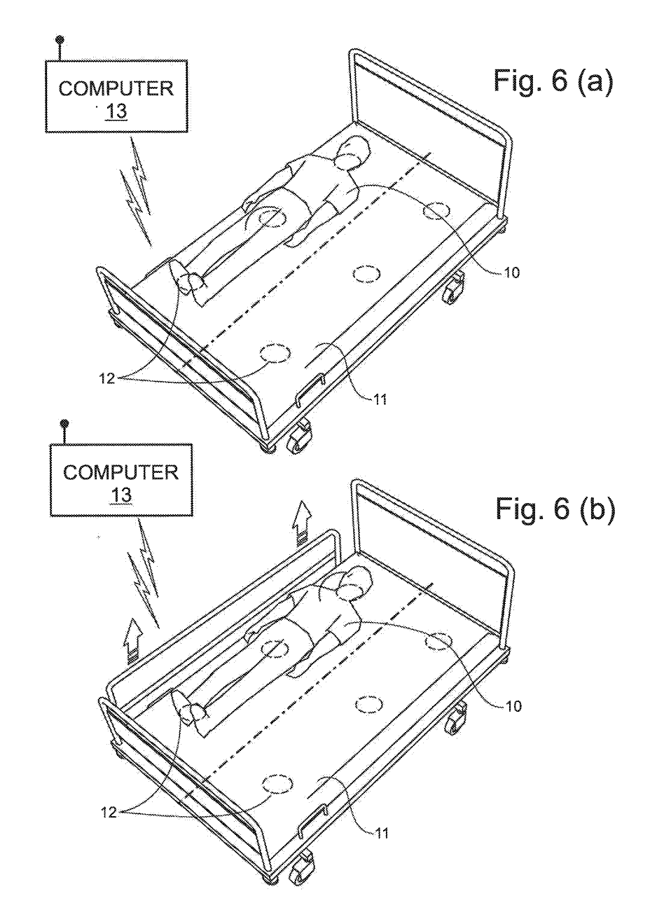

In further detail, FIG. 6(a) shows movement of the patient 10 to the left side of the patient support structure 11 and FIG. 6(b) shows a guard 14 raised on the left side of the patient support structure 11 controlled by the computer system 13 when the position of the patient 10 on the patient support structure 11 is determined to be outside of a chosen deviation from the center of the patient support structure 11.

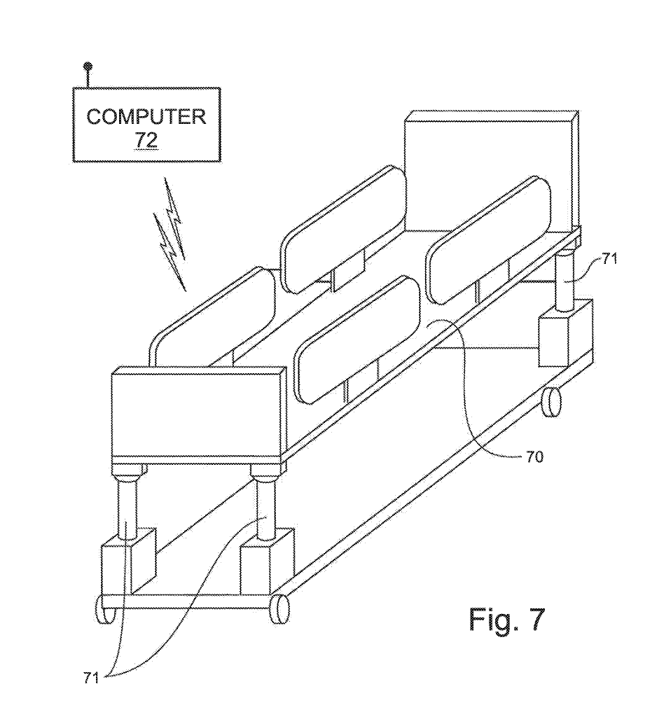

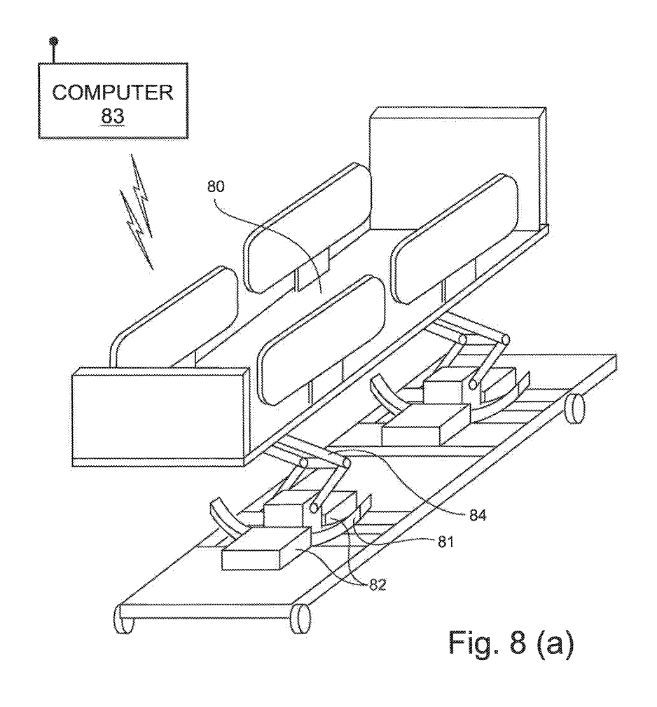

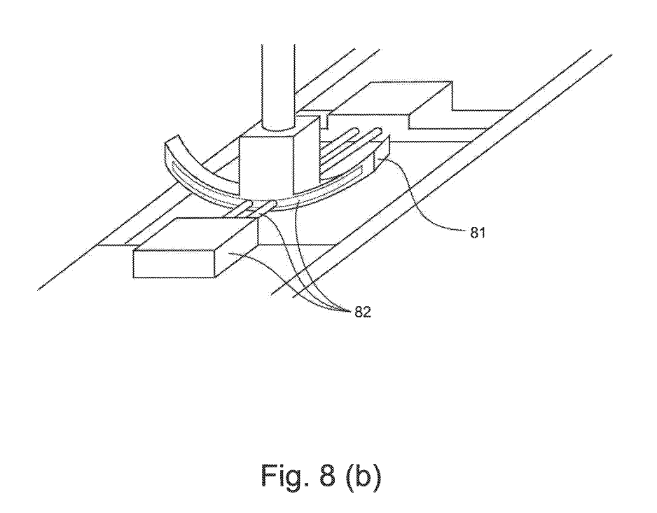

In further detail, FIGS. 7 and 8 show examples of mechanisms controlled by the computer system that can enable the patient support structure to be manipulated to create an inclined plane gravitational force on the patient.

In further detail, FIG. 7 shows a patient support structure 70 coupled to hydraulically powered rams 71 that can be individually controlled by the computer system 72 to adjust the height of each corner of the patient support structure, enabling the patient support structure to tilt in both the longitudinal axis and the transverse axis.

In further detail, FIG. 8(a) shows a patient support structure 80 coupled to support members with a curved base 81 coupled with an electrically powered rack and pinion system 82 controlled by the computer system 83 to enable the patient support structure to tilt in the longitudinal axis. Electrically powered arms 84 controlled by the computer system 83 enable the patient support structure to tilt on its transverse axis. FIG. 8(b) shows an enlarged and exploded view of one of the support members with a curved base 81 coupled with the electrically powered rack and pinion system 82.

Further detail relating to making and using hydraulic and electrical mechanisms is described in U.S. Pat. No. 5,054,140, Bigham, 1991 (“Hospital bed device”); U.S. Pat. No. 3,003,159, Shulkin, 1961 (“Hospital bed”); U.S. Pat. No. 3,908,613, Carpentier, 1974 (“Electric hospital bed”); U.S. Pat. No. 5,636,394, Bartley, 1997 (“Hospital bed with rack and pinion stabilizer”).

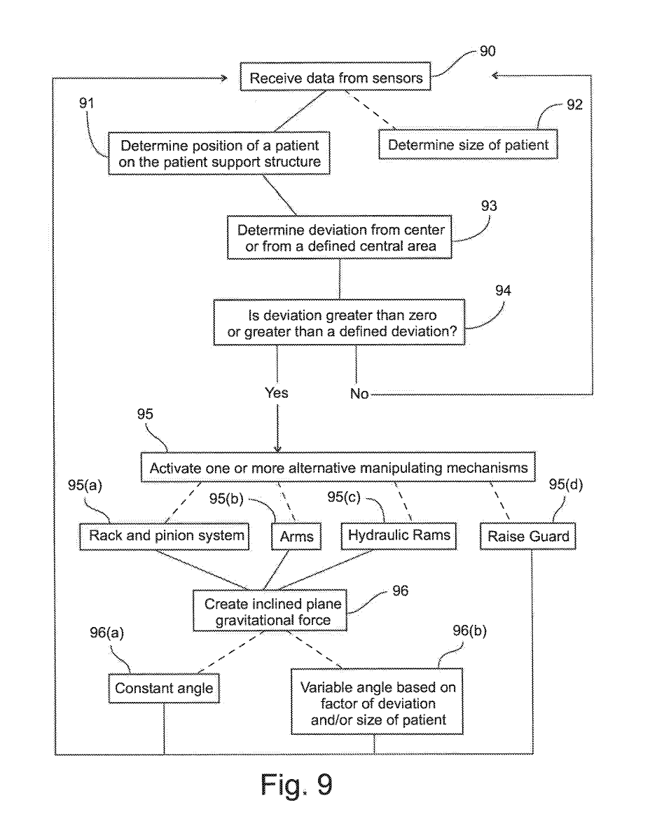

In further detail, FIG. 9 shows a flow chart of an algorithm for a computer program that controls monitoring, repositioning, and protective aspects of various embodiments of the invention. Block 90 is a step to receive data from the sensors. Block 91 is a step to determine the position of a patient on the patient support structure. Block 92 is an optional step to determine the size of the patient, for example in terms of weight, height, or volume. Block 93 is a step to determine the deviation of the position of the patient relative to the center of the patient support structure or from a defined central area. The defined central area may be preprogrammed or selected by the health care provider. For example, the defined central area could be selected by the health care provider to be the middle third of the patient support structure, or any other definable subsection of the patient support structure. Block 94 is a step to determine whether the deviation is greater than zero or greater than a defined deviation. The defined deviation may be preprogrammed or selected by the health care provider. For example, the defined deviation could be selected by the health care provider to be six inches outside of the center or the defined central area or any other definable deviation. If the answer to Block 94 is no, the program is complete and it repeats itself starting back at Block 90. If the answer to Block 94 is yes, Block 95 shows the next step to activate one or more manipulating mechanisms. For example, Block 95(a) activates a rack and pinion system; Block 95(b) activates electric arias; Block 95(c) activates hydraulic rams; and Block 95(d) activates a guard to be raised. Block 96 is a step of controlling the inclined plane gravitational force on the patient from the manipulating mechanisms by determining the angle of incline. Block 96(a) represents the option to create a constant angle in the direction of the center of the patient support structure relative to the patient. Block 96(b) represents the option to create a variable angle in the direction of the center of the patient support structure relative to the patient that is a factor of the deviation and/or the size of the patient. This program repeats itself constantly to achieve responsive repositioning and protective measures as the patient moves on the patient support structure.

Additional features of the inventive subject matter include that the system can be turned on or off. For example, it can be turned on when a health care provider determines that a patient is likely to try to get out of bed and is a fall risk.

Further additional features of the inventive subject matter include that the system can have an optional setting for manually adjusting the bed. This feature allows a health care provider to tilt the bed and roll the patient onto his or her side with the assistance of the bed. The health care provider can activate this feature, for example, when he or she wants a patient rolled into a new position or when he or she wants to change a patient's brief or linens. This will allow fewer individuals to perform these duties and decrease the number of injuries due to lifting and repositioning patients.

Further additional features of the inventive subject matter include that the system can have an optional on- board battery to maintain power in case of power failure or transport.

Further additional features of the inventive subject matter include that the system can be equipped with a gyroscope system to maintain proper positional-orientation.

While the foregoing written description of the invention enables one of ordinary skill to make and use what is considered presently to be the best mode thereof, those of ordinary skill will understand and appreciate the existence of variations, combinations, and equivalents of these specific embodiments. The invention should therefore not be limited by the above described embodiments, but shall include all embodiments within the scope and spirit of the invention.

1. A method for preventing a patient from falling out of a hospital bed comprising the steps of:
a. Providing a patient positioned on a patient support structure;
b. Monitoring the position of the patient on the patient support structure;
c. Manipulating the patient support structure to create an inclined plane gravitational force on the patient in the direction of the center of the patient support structure relative to the position of the patient, so that as the patient moves in the hospital bed the patient is responsively repositioned and protected from falling or exiting from the hospital bed.

2. The method of claim 1 wherein the patient support structure is manipulated by tilting the hospital bed on its longitudinal axis.

3. The method of claim 1 wherein the patient support structure is manipulated by tilting the hospital bed on its longitudinal axis and its transverse axis.

4. The method of claim 1 wherein the patient support structure is manipulated by raising one or more of its sides, top, or bottom above its center.

5. The method of claim 1 wherein the patient support structure is manipulated only when the position of the patient in the patient support structure is determined to be outside of a chosen deviation from the center or a defined central area of the patient support structure, such that the patient support structure otherwise remains level.

6. The method of claim 1 wherein the patient support structure is manipulated to create an inclined gravitational force having an angular degree that is calculated as a factor of the deviation of the position of the patient from the center of the patient support structure.

7. The method of claim 1 wherein the patient support structure is manipulated to create an inclined gravitational force having an angular degree that is calculated as a factor of the weight of the patient and the deviation of the position of the patient from the center of the patient support structure.

8. A hospital bed system comprising:
a. a patient support structure;
b. monitoring means for monitoring the position of a patient on the patient support structure;
c. manipulating means for creating an inclined plane gravitational force on the patient toward the center of the patient support structure relative to the position of the patient, so that as the patient moves the patient is responsively repositioned and protected from falling or exiting from the hospital bed.

9. The system of claim 8 wherein the manipulating means comprises a mechanism for tilting the patient support structure on its longitudinal axis.

10. The system of claim 8 wherein the manipulating means comprises a mechanism for tilting the patient support structure on its longitudinal axis and its transverse axis.

11. The system of claim 8 wherein manipulating means comprises a mechanism for manipulating the patient support structure into a shape where one or more of its sides, top, or bottom are above its center.

12. The system of claim 8 wherein the manipulating means comprises a mechanism having hydraulically powered rams coupled to each corner of the patient support structure, enabling the patient support structure to tilt in both the longitudinal axis and the transverse axis.

13. The system of claim 8 wherein the manipulating means comprises a mechanism having support members with a curved base coupled with an electrically powered rack and pinion system.

14. The system of claim 8 further comprising a computer and a computer program that controls the system.

15. A method for preventing a patient from falling out of a hospital bed comprising the steps of:
a. Providing a patient on a patient support structure;
b. Monitoring the position of the patient on the patient support structure;
c. Raising one or more guards around the perimeter of the patient support structure when the position of the patient on the patient support structure is determined to be outside of a chosen deviation from the center or a defined central area of the hospital bed.
